(19) United States
(12) Patent Application Publication
(10) Pub. No.: US 2007/0203335 A1
(43) Pub. Date: Aug. 30, 2007

(54) Preparation of 6-carboxy-cellulose nitrates

(75) Inventors: Carsten Huttermann, Braunschweig (DE); Thomas Wagner, Walsrode (DE); Jorn-Bernd Pannek, Bad Fallingbostel (DE)

Correspondence Address: CONNOLLY BOVE LODGE & HUTZ, LLP, P O BOX 2207, WILMINGTON, DE, 19899, US

(73) Assignee: Wolff Cellulosics GmbH & Co. KG, Walsrode (DE)

(21) Appl. No.: 11/698,441

(22) Filed: Jan. 26, 2007

(30) Foreign Application Priority Data
Jan. 28, 2006 (DE) 102006004042.2

(51) Int. Cl. C08B 1/04

(52) U.S. Cl. 536/37

(57) ABSTRACT

The present invention relates to a new process for preparing 6-carboxy-cellulose nitrates and also to their use.

### RELATED APPLICATIONS

This application claims benefit to German Patent Application No. 10 2006 004 042.2 filed Jan. 28, 2006, which is incorporated by reference in its entirety for all useful purposes.

### BACKGROUND OF THE INVENTION

1. Field of Invention

The present invention relates to a new process for preparing 6-carboxy-cellulose nitrates and also to their use.

2. Description of the Prior Art

Cellulose nitrates are widely employed as, for example, film formers in wood-coating materials, printing inks, nail varnishes and leather coatings. On account of their hydrophobicity they are used predominantly in organic solutions, imposing a considerable burden on the environment. Even when neutral cellulose nitrates of this kind are incorporated into aqueous systems such as emulsions, this still entails the use of such unwanted organic solvents.

The anionic carboxylate groups of oxidized cellulose nitrates cause them to exhibit much better compatibility with water than in the case of conventional, neutral cellulose nitrates. They can be dispersed effectively in water, which means that they can be used in aqueous formulations. The carboxylate group content per anhydroglucose unit (AGU) ought for this purpose to amount to greater than 0.01.

The state of the art preparation of such oxidized cellulose nitrates involves nitrating celluloses which have already been oxidized. In order to obtain an average carboxylate group content of at least 0.01 per AGU, the required necessary extent of oxidization of the cellulose is so great that it is degraded to a considerable degree at the same time, however. This produces technical problems during the subsequent nitrating process. The degradation of the cellulose is manifested first in a destruction of the fibre structure and second in a reduction in the molecular weight, expressed by a reduction in the intrinsic viscosity. The destruction of cellulose's fibre structure entails a higher fine fraction being obtained at the nitration stage, which, since it passes through screens or filters, leads to losses in yield in the work-up operation.

Furthermore, in the production operation, and particularly in the course of nitration and pressure boiling, these fine particles are degraded chemically, forming, for example, formaldehyde and formic acid and on to CO₂, CO and N₂. This likewise leads to losses in yield and to a greater burden on the waste water.

Additionally, a low intrinsic viscosity implies a higher fraction of low molecular mass cellulose fragments, which owing to the strongly acidic conditions during nitration may undergo further degradation, again reducing the yield.

Moreover, for the use of cellulose nitrates as film binding agents, in leather coatings for example, a high molecular weight and the resulting high viscosity are important factors. For this purpose it is necessary to have as a starting material a cellulose having an appropriately high intrinsic viscosity.

U.S. Pat. No. 2,472,591 describes the preparation of oxidized cellulose nitrate by the simultaneous nitration and oxidation of cellulose through treatment with nitrogen dioxide, anhydrous nitric acid and a haloalkane. A disadvantage of the process is an inadequate nitrogen fraction in the oxidized cellulose nitrate (<8%), which is not sufficient for typical nitrocellulose applications.

U.S. Pat. No. 2,544,902 discloses the preparation of oxidized cellulose nitrates by nitration of oxidized cellulose. In that process cellulose is first oxidized with nitrogen dioxide and then nitrated. A disadvantage of the process is the substantially lower selectivity with respect to the oxidation of the primary hydroxyl group and to the attendant change in fibre structure and to the reduction in molecular weight.

In EP-A 0107867 as well an oxidized cellulose is nitrated, the oxidants used being inorganic compounds such as oxides of nitrogen, oxidizing acids (e.g. perchloric acid) and their metal salts. Owing to the poor selectivity of the oxidation, the products obtainable in this way likewise exhibit molecular weight reduction and a loss of fibre structure.

WO 95/07303 discloses the oxidation of the primary hydroxyl group of carbohydrates, with cellulose being included among those mentioned. The oxidation takes place with TEMPO as primary oxidant and with sodium hypochlorite in the presence of sodium bromide as secondary oxidant. The use of these oxidized celluloses for preparing nitrocelluloses is not described.

WO 01/29309 describes the oxidation of the primary hydroxyl group of cellulose likewise with sterically hindered cyclic oxoammonium compounds as primary oxidant and with a per acid as secondary oxidant. The oxidized cellulose is subsequently stabilized by treatment with a reductant, such as sodium borohydride, for example, or with an oxidant such as sodium chlorite. As a result of the oxidation the fibre structure of the cellulose is retained and the molecular weight of the cellulose is not significantly reduced.

The possibility relating to the nitration of oxidation products of this kind obtainable in accordance with WO 95/07303 or WO 01/29309 is not mentioned in any of the publications. Consequently these publications also do not disclose anything about the application advantages of such nitrates.

It has now been found that specifically 6-carboxy-celluloses of the kind obtainable as described in WO 95/07303 and WO 01/29309 are especially suitable for preparing oxidized cellulose nitrates, since in this way it is possible to reduce disadvantages of the prior art such as yield losses, formation of fine fractions, and severe molecular weight reduction and loss of viscosity.

### SUMMARY OF THE INVENTION

The present invention accordingly provides a process for preparing oxidized cellulose nitrates (“6-carboxy-cellulose nitrates”) by
a) oxidizing cellulose selectively on the C6 carbon at least partially, based on the parent glucose units of the cellulose, and then subjecting the resulting product
b) to nitration.

### A DETAILED DESCRIPTION OF THE INVENTION

The present invention accordingly provides a process for preparing oxidized cellulose nitrates (“6-carboxy-cellulose nitrates”) by
c) oxidizing cellulose selectively on the C6 carbon at least partially, based on the parent glucose units of the cellulose, and then subjecting the resulting product
d) to nitration.

In a) it is possible to use both wood types and linters types of cellulose. These types of cellulose preferably have a non-soluble constituents fraction in 10% strength by weight aqueous sodium hydroxide solution of greater than 80% by weight, preferably greater than 85% by weight, based on the dry anhydrous cellulose.

It is preferred to use celluloses of the aforementioned kind which have an average degree of polymerization (DP) as determined via the intrinsic viscosities (IVs) of 900 to 8500, preferably 1800 to 3000.

Preferred celluloses of this kind typically possess intrinsic viscosities (IVs), measured in a copper(II) ethylenediamine solution in accordance with ISO 5351-1, of 400 to 2200 g/ml, preferably 700 to 1000 g/ml.

The oxidation takes place preferably using sterically hindered oxoammonium compounds, in combination where appropriate with a secondary oxidant.

Suitable sterically hindered oxoammonium compounds for the oxidation of the celluloses are nitrogen oxide compounds in which the nitrogen atom is part of a saturated or unsaturated 5- or 6-membered ring. The other ring atoms may be either carbon or further heteroatoms such as nitrogen, sulphur or oxygen.

Preference is given to those oxoammonium compounds which are stable in aqueous solution or suspension at a pH of 8 to 11. A dispersion is termed stable if after at least 2 days of storage at 23° C. no visible sediment has formed.

Examples of such compounds are the free radicals of 2,2,6,6-tetramethylpiperidinyl 1-oxide (TEMPO), 2,2,2′,2′,6,6,6′,6′-octamethyl-4,4′-bipiperidinyl 1,1′-dioxide (BI-TEMPO), 2,2,6,6-tetramethyl-4-hydroxypiperidinyl 1-oxide, 2,2,6,6-tetramethyl-4-methoxypiperidinyl 1-oxide, 2,2,6,6-tetramethyl-4-benzyloxypiperidinyl 1-oxide, 2,2,6,6-tetramethyl-4-aminopiperidinyl 1-oxide, 2,2,6,6-tetramethyl-4-piperidone 1-oxide, 3,3,5,5-tetramethylmorpholine 1-oxide (TEMMO) and 2,2,5,5-tetramethylpyrrolidinyl 1-oxide. An example of a compound having an unsaturated ring is the free radical of 3,4-dehydro-2,2,6,6-tetramethylpiperidinyl 1-oxide. Preference is given to the radical of 2,2,6,6-tetramethylpiperidinyl 1-oxide (TEMPO).

The preparation of oxoammonium compounds of this kind is familiar to the skilled person and is known from the literature.

The oxidation of stage a) is typically carried out by reacting the cellulose in an aqueous slurry or a suspension with one or a mixture of two or more sterically hindered oxoammonium compounds of the aforementioned kind as oxidant(s). In the course of this oxidation the free radical of the oxoammonium compound is reduced to the corresponding hydroxylamine compound.

Based on the number of C-6 atoms to be oxidized in the cellulose, the oxoammonium compound can be used equimolarly, in excess or in a catalytic, substoichiometric amount. If it is used in a catalytic amount as a primary oxidant, then at the same time it is necessary to use a secondary oxidant equimolarly or in excess, based on the number of C-6 atoms to be oxidized in the cellulose, in order to ensure reoxidation of the amine compound and hence the regeneration of the primary oxidant.

Secondary oxidants of this kind are typically oxidants capable of reoxidizing the hydroxylamine compound in an aqueous slurry or in a dispersion. Examples of suitable oxidants are water-soluble hypohalites, peroxosulphates, peroxodisulphates, oxidizing enzymes and oxidizing transition metal complexes.

To accelerate the reaction it is preferred to use sodium bromide.

The oxidation in step a) is carried out at a temperature of preferably 0 to 30° C., more preferably 0 to 10° C., and at a pH of preferably 8 to 11. The pH may be kept constant using, for example, a mineral base or else using a buffer system.

These specific conditions of the oxidation in step a) produce 6-carboxy-celluloses having a carboxyl group content of 0.01 to 0.15, preferably 0.03 to 0.12, per AGU and an intrinsic viscosity, measured in accordance with ISO 5351-1 in a copper(II) ethylenediamine solution, of more than 300 g/ml, preferably 300 g/ml to 1000 g/ml.

After the oxidation, the 6-carboxy-cellulose can be stabilized by treatment with a reductant or oxidant to counter a reduction in molecular weight, which would imply a reduction in the IV.

Examples of suitable reductants are borohydrides such as sodium borohydride (NaBH₄) and lithium borohydride (LiBH₄) or cyanoborohydrides such as NaBH₃CN. Preference is given to sodium borohydride. Examples of suitable oxidants are alkali metal chlorites, permanganates, chromic acid, bromine, silver oxide, chlorine dioxide and hydrogen peroxide. Preference is given to sodium chlorite.

The 6-carboxy-cellulose is preferably washed with water prior to the nitration in step b), in order to remove the salts formed in the reaction. Where appropriate it is possible to carry out neutralization with an acid, a mineral acid for example, prior to the wash.

The nitration of the 6-carboxy-cellulose obtained according to a) can be carried out in principle in accordance with the known processes for preparing cellulose nitrate (“nitrocellulose”). With preference the nitration takes place in a mixture of nitric acid, sulphuric acid and water.

By the composition of the mixture it is possible for the skilled person to influence the nitrogen content, i.e. the nitrate group content of the cellulose nitrate. This procedure is well known to the skilled person and is described for example in section 1.2 of Ullmann's Encyclopedia of Industrial Chemistry, Cellulose Esters, Klaus Balser, Lutz Hoppe, Theo Eicher, Martin Wandel, Hans-Joachim Astheimer, Hans Steinmeier, John M. Allen, Wiley-VCH Verlag GmbH & Co. KGAA, Weinheim 2005.

The mass ratio of the cellulose employed to the aqueous acid mixture is typically 1:10 to 1:60.

Subsequently the 6-carboxy-cellulose nitrate is stabilized by treatment with hot water. Alternatively or in addition it is possible for this stabilization to be accomplished by pressure boiling with water. For that purpose, where appropriate, water can be added to the moist cellulose nitrate and it can be treated in an autoclave at a temperature above 100° C. A treatment of this kind may take place continuously or batchwise.

Through the duration of pressure boiling it is possible for the skilled person to adjust the viscosity of the 6-carboxy-cellulose nitrate. The rule here is that the longer the pressure boiling, the greater the extent to which the viscosity is reduced. Besides the nitrogen content, the viscosity is an important parameter for nitrocellulose applications. For example, nitrocelluloses featuring a low viscosity are used preferentially in printing inks, whereas medium- and high-viscosity nitrocelluloses are used in wood-coating materials, leather coatings and metal-coating materials.

The two component steps of oxidation and nitration can be carried out in a continuous process in series without a drying step. In this case it is necessary to take account of the water content of the oxidized cellulose at the nitration stage. An alternative possibility is to dry the oxidized cellulose prior to nitration, for example, in order for its interim storage in a non-continuous process. A batch regime may be preferential when the 6-carboxy-cellulose is used in an existing process for preparing non-carboxylated nitrocellulose. The existing process can be used, with the cellulose merely being replaced by 6-carboxy-cellulose. It is likewise possible to prepare 6-carboxy-cellulose nitrate alongside nitrocellulose in an existing plant, which is very advantageous for an economic configuration of the plant.

Since in the course of the nitration there is virtually no recordable loss of carboxyl groups, the carboxyl group content of the 6-carboxy-cellulose nitrates obtained after step b) is 0.01 to 0.15, preferably 0.03 to 0.12 per AGU.

The 6-carboxy-cellulose nitrates obtainable in accordance with the invention can be dispersed effectively in water. The dispersions are stable at 23° C. for a number of days without forming any visible sediment.

For this purpose they can be dispersed as solids directly in water. Preferably though, they are first dissolved in an organic solvent and then dispersed in water. Preferred organic solvents for this purpose are aliphatic ketones. Particular preference is given to acetone. The organic solvent can then be removed again from the ready-prepared dispersion later on, which can be accomplished easily by heating, preferably under reduced pressure.

When preparing aqueous dispersions of this kind it is preferred to carry out complete or partial conversion of the inventively obtainable 6-carboxy-cellulose nitrates into their anionic form, by deprotonation of the COOH groups. This can be achieved by adding a base. The base may either be added prior to dispersion or be already present, in dissolved form, in the water used for dispersing.

The amount of added base, based on the carboxylic acid and/or carboxylate functions present, is preferably 0.5 to 1.5, more preferably 0.7 to 1.0.

Possible bases that can be used for the deprotonation include not only mineral bases, such as, for example, the hydroxides of the alkali metals, but also organic bases, such as amines, for example.

Preference is given to amines of the type NR₁R₂R₃, in which R₁, R₂ and R₃ are hydrogen or amino-alkyl, alkyl, aryl or alkenyl radicals. Particular preference is given to ammonia, ethylamine, propylamine, butylamine, diethylamine, dipropylamine, dipropylenetriamine, trimethylamine, triethylamine, ethylenediamine, diethylenetriamine, ethanolamine, dimethylaminoethanol, trimethanolamine, pyridine, aniline, urotropine, 3-aminopropene, diallylamine, morpholine and isophoronediamine.

Aqueous dispersions of this kind typically have solids contents of 10% to 50% by weight, preferably 10% to 40% by weight, more preferably 20% to 35% by weight. Dispersions of this kind are of lower viscosity, and possess higher solids contents, than the typical organic cellulose nitrate solutions.

The stability of the dispersions can be raised through the addition of stabilizers, such as surfactants, for example. It is likewise possible to mix in additives which enhance the properties of the dispersions with respect to their particular application. Such additives may be, for example, plasticizing or film-forming substances.

Examples of possible plasticizers include fatty acid esters, triacetin, diethylene glycol monobutyl ether, dipropylene glycol dimethyl ether, 2,2,4-trimethyl-1,3-pentanediol monoisobutyrate, butyl polyglycol, phthalic esters such as diisobutyl phthalate and dibutyl phthalate, and polyethylene glycol.

It is also possible, however, to disperse the 6-carboxy-cellulose nitrates with other aqueous systems to form stable dispersions. Suitable such further aqueous systems include, for example, alkyd, acrylate or polyurethane dispersions.

These dispersions with 6-carboxy-cellulose nitrate can be formulated in such a way that they may be used, for example, as leather-coating or wood-coating compositions. In those fields cellulose nitrates in the form of solvent-borne coating compositions are frequently employed on the basis of their outstanding properties, such as gloss, sandability, hardness and grain highlighting, for example.

### EXAMPLES

The intrinsic viscosities (IVs) of the celluloses and 6-carboxy-celluloses were carried out in accordance with ISO 5351-1 in a copper(II) ethylenediamine solution.

The carboxyl group content of the oxidized celluloses was determined in accordance with ASTM D 1926-00. From the content it is possible to calculate the degree of substitution in terms of carboxyl groups (DS(carboxyl)).

The nitrogen content of the cellulose nitrates and of the oxidized cellulose nitrates was determined by the method according to Schlösing-Schulze-Tiemann. This method involves heating the nitrate with iron(II) chloride and hydrochloric acid, thereby reducing the nitrate radical to NO. The NO captured is subjected to quantitative determination and the weight (nitrogen fraction, %) is calculated from the reduced volume.

The determination of the degree of substitution in terms of acid groups in the cellulose nitrates (DS(carboxyl)) was made by means of potentiometric titration. In this case a fraction of the purified cellulose nitrates was dissolved in methanol and that solution was titrated against an ethanolic sodium hydroxide solution. From the end point it was possible to determine the number of anionic groups per unit mass. From the combination of these values and the respective nitrogen contents, the degrees of substitution were determined.

### Examples 1-3

### Selective Oxidation of Cellulose to 6-Carboxy-Cellulose

100 g of defiberized cellulose (IV:751 ml/g) are suspended in 3 l of water and the suspension is cooled to 5° C. and admixed with 0.96 g of TEMPO and 19 g of NaBr. The pH of the suspension is adjusted to 9.5 using NaOH solution (2% by weight). Then sodium hypochlorite (NaClO) is slowly added dropwise as a solution (5% by weight) with stirring. The mixture is stirred at 5° C. for 3 hours. During the addition of hypochlorite and the subsequent reaction period the pH is held constant at 9.5 using NaOH solution (2% by weight). The reaction is terminated by addition of sodium borohydride (NaBH₄) and stirred at 20° C. for an hour. Subsequently the oxidized cellulose is separated off, washed with 3 times 3 l of water, dried in a forced-air drying cabinet at 55° C. and milled in an impact mill with a 10 mm perforated disc at 10 000 rpm.

| | Example: | | |
|---|---|---|---|
| | 1 | 2 | 3 |
| NaClO solution (5% by weight), g | 30.2 | 90.6 | 151.0 |
| NaOH solution (2% by weight), g | 27.8 | 98.4 | 180.1 |
| NaBH₄, g | 2.3 | 7.0 | 11.7 |
| Carboxyl groups, mmol/100 g | 17.8 | 53.0 | 84.1 |
| DS(carboxyl) | 0.03 | 0.09 | 0.14 |
| IV, ml/g | 634 | 556 | 390 |

### Examples 4-9

### Nitration of 6-Carboxy-Cellulose

6-Carboxy-cellulose is introduced with stirring into 2 l of a mixture (“nitrating acid”) of nitric acid (HNO₃), sulphuric acid (H₂SO₄) and water and stirred at 30° C. for 45 minutes. Subsequently the cellulose nitrate is separated from the acid on a frit, suspended in ice-water and washed repeatedly with water to neutrality. The cellulose nitrate is treated with boiling water for 20 minutes and washed with cold water. Thereafter the cellulose nitrate is transferred to a laboratory autoclave, admixed with sufficient water to develop a pressure of approximately 3 bar at 142° C., and boiled at 142° C. for 45 minutes.

| | Example | | | | | |
|---|---|---|---|---|---|---|
| | 4 | 5 | 6 | 7 | 8 | 9 |
| 6-Carboxy-cellulose, g | Example | Example | Example | Example | Example | Example |
| | 1, 42.31 | 1, 42.3 | 2, 42.5 | 2, 42.5 | 3, 42.4 | 3, 42.4 |
| Nitrating acid | 20/62/18 | 21/62/17 | 20/62/18 | 21/62/17 | 20/62/18 | 21/62/17 |
| (HNO₃/H₂SO₄/H₂O), % | | | | | | |
| by weight | | | | | | |
| Nitrogen content, | 11.71 | 12.16 | 11.24 | 11.58 | 11.17 | 11.46 |
| % by weight | | | | | | |
| Carboxyl groups, | 8.9 | 9.2 | 26.5 | 27.3 | 40.6 | 43.1 |
| mmol/100 g | | | | | | |
| DS(NO₃) | 2.18 | 2.32 | 2.05 | 2.15 | 2.03 | 2.12 |
| DS(carboxyl) | 0.02 | 0.02 | 0.07 | 0.07 | 0.10 | 0.11 |
| Final weight, g | 57.2 | 60.4 | 53.7 | 54.2 | 49.3 | 53.7 |
| Yield, % | 84.4 | 87.1 | 81.0 | 80.3 | 74.8 | 80.3 |

### Comparative Examples 1-4

### Oxidation of cellulose

The oxidation took place in accordance with a specification by V. Kumar and T. Yang (Carbohydrate Polymers, Vol. 48, (2002), pp. 403-412).

100 g of defiberized cellulose (IV: 751 ml/g) are suspended in 1400 ml of a mixture of nitric acid (65%) and phosphoric acid (85%) in a volume ratio of 2:1. 20 g of sodium nitrite (NaNO₂) in solid form are introduced into the mixture in one go, causing dark brown vapours to ascend immediately. The mixture is stirred at room temperature for the time indicated. Subsequently the cellulose is separated off on a frit, suspended in ice-water and washed with 4 times 4 l of water. The oxidized cellulose is dried at 55° C. in a forced-air drying cabinet and milled in an impact mill with a 10 mm perforated disc at 10 000 rpm.

| | Example | | | |
|---|---|---|---|---|
| | C1 | C2 | C3 | C4 |
| Reaction time, min | 60 | 120 | 180 | 240 |
| Carboxyl groups, mmol/100 g | 12.1 | 35.2 | 43.6 | 64.9 |
| DS(carboxyl) | 0.02 | 0.06 | 0.07 | 0.11 |
| IV, g/ml | 77 | 68 | 62 | 60 |

### Comparative Examples C5-C8

### Nitration of the Degraded, Oxidized Cellulose

The nitration of the oxidized celluloses from Comparative Examples C1 to C4 took place as described in Examples C5 to C8.

| | Example | | | |
|---|---|---|---|---|
| | C5 | C6 | C7 | C8 |
| 6-Carboxy-cellulose, g | Example | Example | Example | Example |
| | C1, 42.7 | C2, 42.4 | C3, 42.6 | C4, 44.2 |
| Nitrating acid | 20/62/18 | 20/62/18 | 20/62/18 | 20/62/18 |
| (HNO₃/H₂SO₄/H₂O), | | | | |
| % by weight | | | | |
| Nitrogen content, | 11.57 | 11.24 | 11.17 | 10.96 |
| % by weight | | | | |
| Carboxyl groups, | 9.7 | 23.2 | 26.1 | 33.6 |
| mmol/100 g | | | | |
| DS(NO₃) | 2.14 | 2.05 | 2.03 | 1.97 |
| DS(carboxyl) | 0.03 | 0.06 | 0.07 | 0.08 |
| Final weight, g | 55.8 | 51.6 | 47.9 | 43.0 |
| Yield, % | 82.1 | 77.7 | 72.1 | 63.1 |

The examples show that the yield of the nitration when oxidized celluloses having a high intrinsic viscosity are used in accordance with the invention is higher than when degraded, oxidized cellulose is used.

### Examples 10-15

### Dispersions with 6-Carboxy-Cellulose Nitrates

5 g of (bone-dry) cellulose nitrate are dissolved in 20 g of acetone and neutralized with 0.2 g of dimethylaminoethanol. Subsequently the solution is dispersed with 20 g of water, with the aid of an Ultra-Turrax. The acetone is removed from the resulting dispersion under reduced pressure. The dispersions are assessed visually. The dispersion obtained is stable if after at least 2 days there is no visible formation of sediment.

| | Cellulose nitrate | |
|---|---|---|
| Example | from Example | Result |
| 10 | 4 | Dispersion with 86% by volume sediment |
| 11 | 5 | Dispersion with 74% by volume sediment |
| 12 | 6 | Stable dispersion |
| 13 | 7 | Stable dispersion |
| 14 | 8 | Stable dispersion |
| 15 | 9 | Stable dispersion |

### Comparative Examples C9-C12

### Dispersions with Degraded, Oxidized Cellulose Nitrates

The dispersions with the cellulose nitrates from Comparative Examples C5 to C8 were prepared in the same way as for Examples 10 to 15.

| | Cellulose nitrate | |
|---|---|---|
| Comparative | from Comparative | |
| Example | Example | Result |
| 9 | C5 | Not dispersible, the cellulose |
| | | nitrate is in the form of a viscous |
| | | mass |
| 10 | C6 | Unstable, cellulose nitrate settles |
| | | out immediately |
| 11 | C7 | Unstable, cellulose nitrate settles |
| | | out immediately |
| 12 | C8 | Stable dispersion |

From Comparative Examples C9 to C12 it is apparent that the oxidized nitrocelluloses obtainable by conventional oxidation lead to dispersions of markedly poorer quality as compared with those obtainable in accordance with the invention.

All the references described above are incorporated by reference in its entirety for all useful purposes.

While there is shown and described certain specific structures embodying the invention, it will be manifest to those skilled in the art that various modifications and rearrangements of the parts may be made without departing from the spirit and scope of the underlying inventive concept

1. A process for preparing oxidized cellulose nitrates (“6-carboxy-cellulose nitrates”) which comprises
a) oxidizing cellulose selectively on the C6 carbon at least partially, based on the parent glucose units of the cellulose, and then subjecting the resulting product
b) to nitration.

2. The process according to claim 1, wherein the oxidants used in a) are sterically hindered oxoammonium compounds in combination where appropriate with a secondary oxidant.

3. The process according to claim 2, wherein the 2,2,6,6-tetramethylpiperidinyl 1-oxide (TEMPO) is used as sterically hindered oxoammonium compounds in a).

4. The process according to claim 1, wherein the cellulose employed in a) has an average degree of polymerization (DP) as determined via the intrinsic viscosities (IVs) of 900 to 8500.

5. The process according to claim 1, wherein the oxidation is carried out at a temperature of 0 to 30° C. and a pH of 8 to 11.

6. The process according to claim 1, wherein after step a) and before nitration sodium borohydride or alkali metal chlorites are added for the purpose of stabilization.

7. The process according to claim 1, wherein the nitration in b) is carried out using a mixture of nitric acid, sulphuric acid and water.

8. The process according to claim 3, wherein the cellulose employed in a) has an average degree of polymerization (DP) as determined via the intrinsic viscosities (IVs) of 1800 to 3000.

9. The process according to claim 8, wherein the oxidation is carried out at a temperature of 0 to 10° C. and a pH of 8 to 11.

10. The process according to claim 9, wherein after step a) and before nitration sodium borohydride or alkali metal chlorites are added for the purpose of stabilization.

11. The process according to claim 10, wherein the nitration in b) is carried out using a mixture of nitric acid, sulphuric acid and water.

12. A product containing 6-carboxy-cellulose nitrate, obtainable by a process according to claim 1.

13. The product according to claim 12, wherein the product has a carboxyl group content of 0.01 to 0.15 per AGU.

14. The product according to claim 12, wherein the product has a carboxyl group content of 0.03 to 0.12 per AGU.

15. An aqueous dispersion comprising the product according to claim 12.

16. The aqueous dispersion as claimed in claim 15 which has a solids content of 10 to 50% by weight.

17. The aqueous dispersion as claimed in claim 15 which has a solids content of 20 to 35% by weight.

18. An ink or paint which comprises the product as claimed in claim 12.

19. A process to prepare an ink or paint which comprises using the product as claimed in claim 12.

20. A process to prepare a coating which comprises using the product as claimed in claim 12.

21. The process as claimed in claim 20 wherein leather or wood is coated.

22. Substrates coated with coatings obtainable using products containing 6-carboxy-cellulose nitrate.
